(19) United States
(12) Patent Application Publication
(10) Pub. No.: US 2008/0059478 A1
(43) Pub. Date: Mar. 6, 2008

(54) Methods, systems, and computer program products for organizing and sharing content

(76) Inventor: Ari Craine, Marietta, GA (US)

Correspondence Address: MYERS BIGEL SIBLEY & SAJOVEC, P.A., P.O. BOX 37428, RALEIGH, NC, 27627, US

(21) Appl. No.: 11/513,531

(22) Filed: Aug. 31, 2006

(51) Int. Cl. G06F 17/30

(52) U.S. Cl. 707/10

(57) ABSTRACT

Methods, systems and computer program products for creating and sharing content lists are provided. A user content list is created via a user device, and shared with selected other users via a network service. A user's content list can be shared with other users selected by the user. A user's content list can be shared with others based on the type of content other users are interested in. A user's content list can be shared with a second user based on content identified in a content list that the second user has transmitted to the network service. The network service is configured to categorize content on a user content list. The network service can categorize content alphabetically, chronologically, by genre, by type of content, and/or by one or more combinations thereof.

### FIELD OF THE INVENTION

The present invention relates generally to communications networks, and, more particularly, to methods, systems, and computer program products for obtaining content via communications networks.

### BACKGROUND OF THE INVENTION

Communications networks are widely used for nationwide and worldwide communication of voice, multimedia and/or data. As used herein, the term “communications networks” includes public communications networks, such as the Public Switched Telephone Network (PSTN), terrestrial and/or satellite cellular networks, private networks and/or the Internet.

The Internet is a decentralized network of computers that can communicate with one another via Internet Protocol (IP). The Internet includes the World Wide Web (web) service facility, which is a client/server-based facility that includes a large number of servers (computers connected to the Internet) on which web pages or files reside, as well as clients (web browsers), which interface users with the web pages. The topology of the web can be described as a network of networks, with providers of network services called Network Service Providers, or NSPs. Servers that provide application-layer services may be referred to as Application Service Providers (ASPs). Sometimes a single service provider provides both functions.

Vast amounts of information or “content” are available on the web including, but not limited to text, images, applications, video, and audio content. Web users are also increasingly making their own personal content (e.g., home movies, photograph albums, audio recordings, etc.) available via the web through web sites, web logs (blogs), and the like. In addition, television networks, including traditional broadcast networks as well as cable and satellite television networks, are making content available via the web. Unfortunately, the sheer amount of available content and the increasing numbers of content providers are posing increasingly more difficult challenges to users with respect to finding content of interest.

### SUMMARY OF THE INVENTION

According to embodiments of the present invention, systems, methods, and computer program products are provided that facilitate organizing and sharing of content via a communications network. According to some embodiments of the present invention, a user content list is created using, for example, a user device, and the created user content list is shared with selected other users via the network. Creating a content list includes identifying content and providing an address for the identified content, wherein the address is an address from which the content can be retrieved via the network. Identifying user content includes tagging content (i.e., associating a tag descriptor with content) a user is currently viewing via a device (e.g., personal computer, wireless communications device, packet-based network video device, etc.) upon which the user is viewing the content. Identifying user content includes identifying content a user wishes to obtain, but does not have in his/her possession at the present time. Identified content may be rated, ranked.

According to some embodiments of the present invention, sharing a user content list includes transmitting the user content list to a network service. The network service is configured to share the user content list with selected other users via the network. For example, a user's content list can be shared with other users selected by the user. A user's content list can be shared with others based on the type of content other users are interested in. For example, the network service can share a user's content list with a second user in response to the second user searching, via the network service, for content that is related to content on the user content list. The network service can share a user's content list with a second user based on content identified in a content list that the second user has transmitted to the network service. A user content list may be shared via guides and listings that are created.

According to other embodiments of the present invention, the network service is configured to categorize content and/or facilitate user categorization of content on a user content list. The network service can categorize content alphabetically, chronologically, by genre, by type of content, and/or by one or more combinations thereof.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which form a part of the specification, illustrate key embodiments of the present invention. The drawings and description together serve to fully explain the invention.

FIGS. 1-4 are flow charts that illustrate exemplary operations for organizing and sharing content via a network, according to some embodiments of the present invention.

FIG. 5 is a block diagram that illustrates a software/hardware architecture for organizing and sharing content via a network, according to some embodiments of the present invention.

FIG. 6 is a block diagram that illustrates a processor and a memory hosted by a device that may be used in embodiments of a network service that organizes and shares user content, according to some embodiments of the present invention.

### DETAILED DESCRIPTION OF EMBODIMENTS OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “content” means any type of audio content, video content, audio/video content, text, gaming content, interactive content, application content, etc., that can be delivered and/or performed/displayed via a communications network. For example, content may include television programs, movies, voice messages, music and other audio files, electronic mail/messages, web pages, interactive games, educational materials, software applications, etc.

Computer program code for carrying out operations of data processing systems discussed herein may be written in a high-level programming language, such as Java, AJAX (Asynchronous JavaScript), C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. Embodiments of the present invention are not limited to a particular programming language. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. These flowchart and/or block diagrams further illustrate exemplary operations for organizing and sharing content via a communications network, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

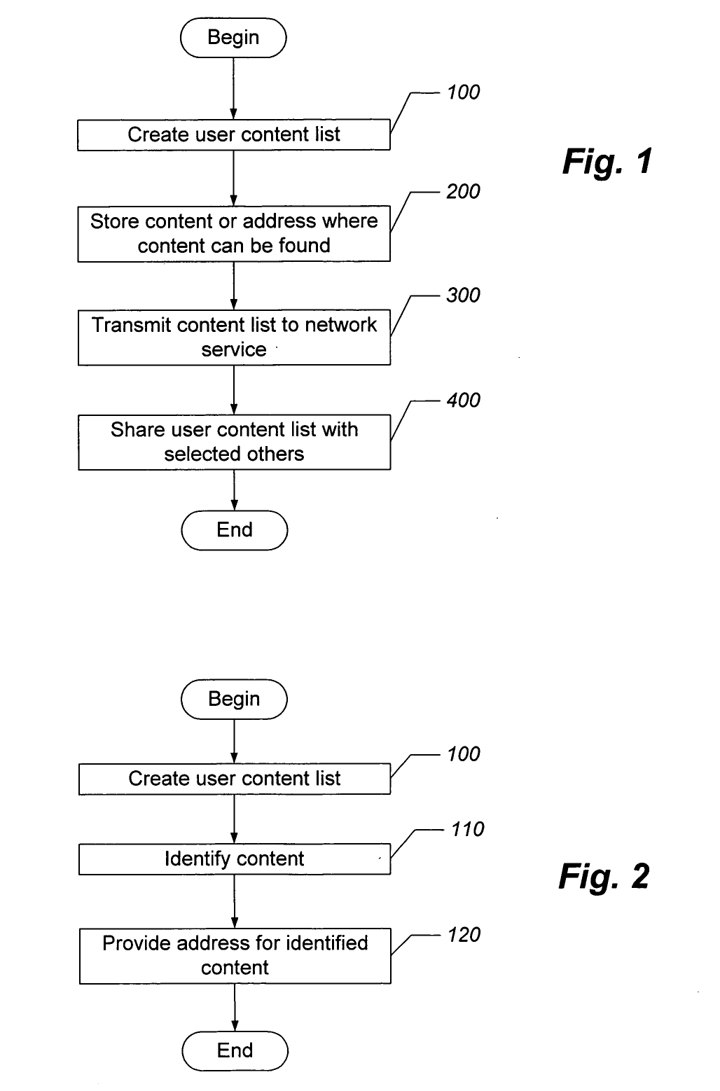

Exemplary operations for organizing and sharing content, according to some embodiments of the present invention, will now be described with reference to FIGS. 1-4. Referring initially to FIG. 1, a user creates a content list (Block 100), stores the content and/or an address (vector) where content can be found (Block 200), transmits the user content list to a network service (Block 300), and then shares the content list with selected other users via a network service (Block 400).

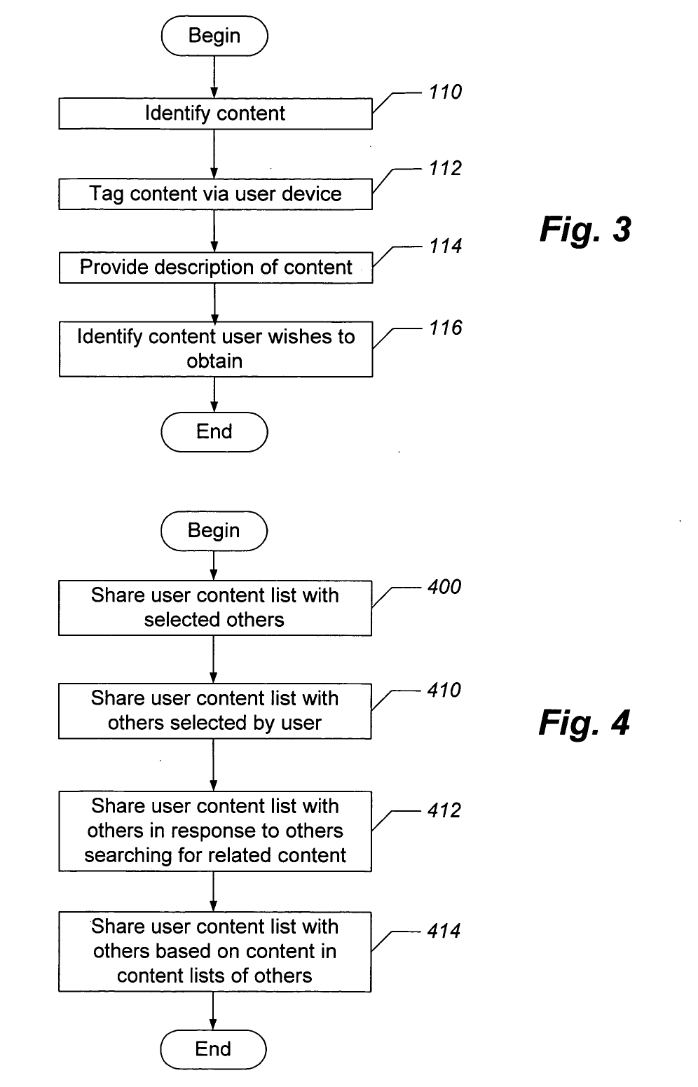

A content list may be created by a user by first identifying content (Block 110, FIG. 2) and providing an address for the identified content (Block 120, FIG. 2). The content may be from one or more devices, domains and/or systems. For example, content may be selected from a handheld device (e.g., a video playing on a Blackberry® device), a television program playing on a home television, an audio file playing on a device in a vehicle, etc. Content can be identified by a user in numerous ways including “tagging” content via a user device (Block 112, FIG. 3), providing a description of content to a user device (Block 114, FIG. 3), and/or identifying, via a user device, content a user wishes to obtain in the future (Block 116, FIG. 3).

Tagging content (Block 112, FIG. 3), as used herein, means any method of identifying (i.e., associating a tag descriptor with) a content file (e.g., a web page, a video file, an audio file, a television program, etc.) and an address for the content via a user interface of a device. A tag descriptor can be, for example, a category label, a keyword(s), a cue, a prompt, a reminder, something to indicate similarity, etc. A tag descriptor may create metadata for content.

For example, “bookmarking” a displayed web page via a browser is a form of tagging content because a description of the content is captured along with an address (e.g., a universal resource locator (URL)) that identifies where the content can be obtained. Content listed in displayed search results can be tagged. For example, from the displayed results of a search conducted on the Internet or other network via a search engine, tag descriptors can be associated with content by a user device and added to a content list.

There is a social aspect to tagging content, according to embodiments of the present invention, as well. For example, tag descriptors can be associated with the content of other people. For example, user A can add tag descriptors to the content lists of user B. Tag descriptors for content can come from other sources including, but not limited to, other people, devices, behavior of people, etc.

Tagging content, according to some embodiments of the present invention may include rating and/or ranking content, and may include accruing usage data associated with content such as analytical information about the content, demographic information about users who use the content, etc.

According to some embodiments of the present invention, there may be relationships (orthogonal, hierarchical, heterarchical, etc.) among tag descriptors. Tag descriptors may become organized according to such relationships. However, tag descriptor relationships need not be hierarchical. Tag descriptor relationships may be orthogonal. This may be facilitated, for example, with some information structures such as ontological constructs which use linguistic links among elements including “also known as” or “may be related to.” This allows more freedom in associations among tag descriptors. As an example, a tag descriptor associated with content related to bicycle pumps may be orthogonally related to a tag descriptor associated with content related to ducks (because bicycle pumps may be utilized in the preparation of certain duck food dishes).

Tag descriptors for content can come from other sources including, but not limited to, other people, devices, the behavior of people, etc. Moreover, tag descriptors need not be originated by a person. Tag descriptors can be generated automatically based on various events, behavior, etc.

Various other ways of tagging content are within the scope of the present invention. For example, tagging content can be performed via a remote control, wireless device, keyboard, instant messaging (IM), portal access, etc.

User devices, according to embodiments of the present invention can be configured to allow a user to identify content of virtually any type and hosted at virtually any location. For example, a user can identify a video file located at a first website, an audio file located at a second website, a television program that is available from an online television program provider, etc.

According to some embodiments of the present invention, a user can create a content list or add to an existing content list via a user device by providing information about content the user would like to obtain/view/listen to in the future, etc. For example, a user can input the types of movies (e.g., comedies, westerns, etc.) the user would like to view, the types of music the user would like to listen to (e.g., classical, alternative country, etc.). The user will likely not have an address of content he/she wishes to obtain. The network service, described below, is configured to provide description and address information as it locates content that satisfies what the user is looking for.

As a user creates a content list, he/she transmits the content list to the network service (Block 200). This step can occur virtually anytime during content list creation/editing. For example, a content list can be completed by a user first and then transmitted to the network service. Alternatively, a user can continuously add to an existing content list and/or edit an existing content list already transmitted to the network service. In addition, a user can create multiple content lists, etc. A content list can be transmitted to the network service via a user device in various ways, without limitation. For example, a content list can be transmitted via e-mail, via a web page, via facsimile transmission, etc.

The network service may be configured to dynamically organize or configure a user's content list, according to some embodiments of the present invention. The network service can organize a user's content list in various ways. For example, a content list can be organized alphabetically, chronologically, by genre (e.g., action, comedy, drama, sports, etc.), by type of content, media type (e.g., video, audio, stills, duration, size, etc.), date content acquired and/or tagged, rating, ranking, usage, and/or by one or more combinations thereof.

According to some embodiments of the present invention, the network service may be configured to dynamically update user content lists as the network service becomes aware of content. For example, the network service may be configured to infer what content a user would like added to his/her content list(s). This may be facilitated by including content media to a dynamic content list that a user does not currently own. This inclusion in the list of content media that the user does not own denotes interest in the content media, content media type, content media category, and social networks and/or groups.

The network service is configured to share a user's content list with other users (Block 400) in various ways. For example, a user's content list can be shared with other users selected by the user (Block 410, FIG. 4). In addition, according to some embodiments of the present invention, a user's content list can be shared with others based on the type of content other users are interested in. For example, the network service may share a user's content list with a second user in response to the second user searching, via the network service, for content that is related to content on the user content list (Block 412, FIG. 4). According to some embodiments of the present invention, the network service may share a user's content list with a second user based on content identified in a content list that the second user has transmitted to the network service (Block 414, FIG. 4).

According to some embodiments of the present invention, the network service may be configured to facilitate a collaborative aspect of creating and editing content lists among users. For example, user A may be allowed to add content and tag descriptors to a content list of user B, and vice versa, etc. Moreover, user A and user B may have a joint content list.

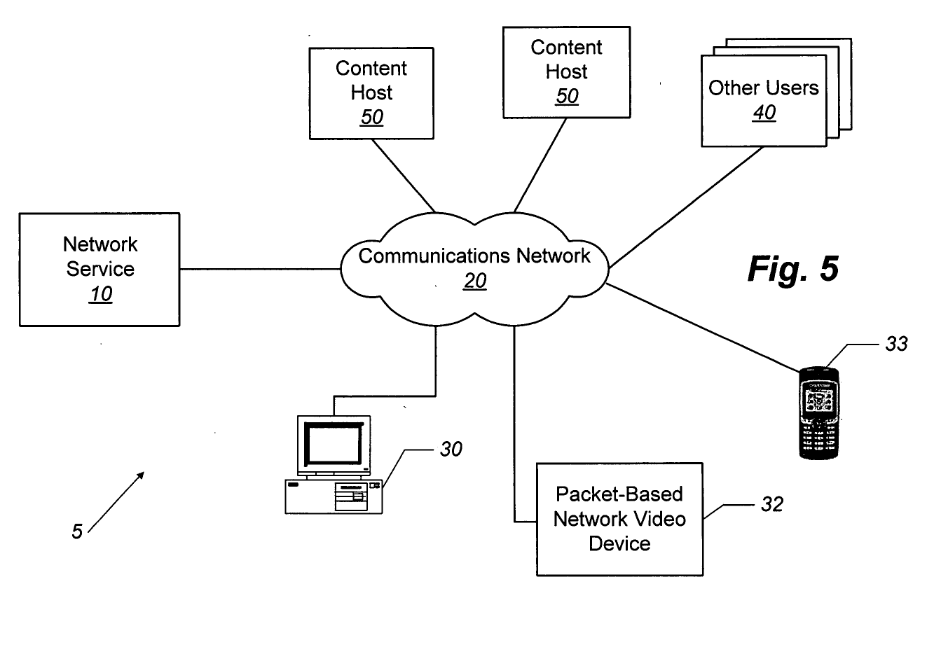

Referring to FIG. 5, a system 5 for organizing and sharing content, according to some embodiments of the present invention, is illustrated. The illustrated system 5 includes a network service 10 that is in communication with the network 20. Via user devices, such as personal computer 30, wireless communications device 33, packet-based network video device 32, etc., a user creates a user content list and transmits the user content list to the network service 10. According to some embodiments of the present invention, each user device includes software code that serves as means for creating a user content list and means for transmitting the user content list to the network service 10. According to some embodiments of the present invention, the network service 10 may include software code that serves as means for creating a user content list and means for transmitting the user content list from a user device to the network service 10. The software code for creating a user content list includes software code for identifying content, and software code for providing an address (or reference point) for the identified content. The address identifies where the content can be retrieved via the network 20. An exemplary address is a URL. However, other types of addresses/reference points can be utilized. For example, other types of addresses/reference points include, but are not limited to, eCommerce and promotional web sites, electronic program guides (EPG), catalogs, listings (e.g., video-on-demand libraries, etc.), RSS descriptor/feeds, etc.

According to some embodiments of the present invention, software code for identifying content is configured to tag content displayed/performed in the user device, as described above. According to some embodiments of the present invention, software code for identifying content is configured to allow a user to identify content he/she wishes to obtain in the future, as described above.

Software code for performing various functions of the present invention (e.g., identifying content) may reside and/or execute entirely on a user device, entirely on the network service, or partially on the network service and a user device.

According to some embodiments of the present invention, the network service 10 is configured to share a user content list with selected other users 40 via the network 20. As described above, the network service 10 can share a user's content list with others designated by the user. According to some embodiments of the present invention, the network service 10 is configured to share a user content list with a second user 40 in response to the second user 40 searching, via the network 20, for content that is related to content on the user content list. According to some embodiments of the present invention, the network service 10 is configured to share the user content list with a second user based on content identified on a second user content list transmitted to the network service by the second user.

According to some embodiments of the present invention, the network service 10 is configured to categorize content on user content lists. As described above, the network service 10 can categorize content alphabetically, chronologically, by genre, by type of content, and/or by one or more combinations thereof, etc.

The communications network 20 may represent a global network, such as the Internet, or other publicly accessible network. The communications network 20 may also, however, represent a wide area network, a local area network, an Intranet, or other private network, which may not accessible by the general public. Furthermore, the communications network 20 may represent a combination of public and private networks or a virtual private network (VPN). The communications network 20 may also contain transmissions over-the-air or through a dedicated distribution network. The communications network 20 may also be wireless or wireline, or may include wireless and wireline portions.

In operation, a user, via a device, such as a computing device 30, wireless device 33, or packet-based network video device, etc. 33, connected to the communications network 20, creates a user content list and transmits the list to the network service 10. The network service 10 helps the user to organize/categorize the content as described above. The network service 10 shares the user content list, or one or more portions thereof, with other users, as described above.

Although FIG. 5 illustrates an exemplary system for organizing and sharing content, it will be understood that the present invention is not limited to such configurations, but is intended to encompass any configuration capable of carrying out the operations described herein.

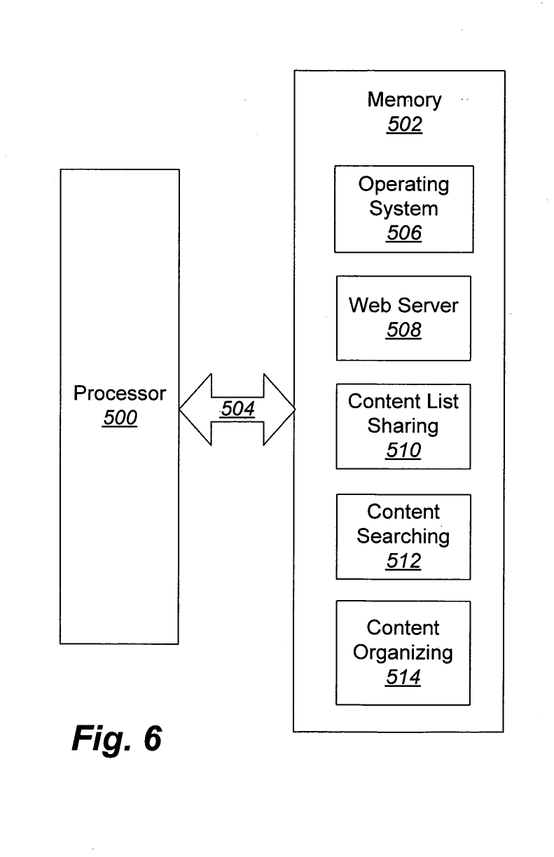

FIG. 6 illustrates a processor 500 and a memory 502 hosted by a device that may be used in embodiments of methods, systems, computer networks, and computer program products for a network service that organizes and shares user content, according to some embodiments of the present invention. The processor 500 communicates with the memory 502 via an address/data bus 504. The processor 500 may be, for example, a commercially available or custom microprocessor. The memory 502 is representative of the overall hierarchy of memory devices containing the software and data used to execute the network service for organizing and sharing content as described herein, in accordance with some embodiments of the present invention. The memory 502 may include, but is not limited to, the following types of devices: cache, ROM, PROM, EPROM, EEPROM, flash, SRAM, and DRAM.

As shown in FIG. 6, the memory 502 may hold various categories of software and data: an operating system 506, web server 508, content list sharing application 510, content searching application 512, and content organizing application 514. The operating system 506 controls operations of the network service device(s). In particular, the operating system 506 may manage a network service device's resources and may coordinate execution of various programs (e.g., the content list sharing application, content searching application, content organizing application, etc.) by the processor 500.

The web server 508 handles requests and communications from user devices and responds to requesting user devices (e.g., serves files forming web pages to web users, etc.). The web server 508 also handles the processing of requests from user devices via the content list sharing application 510, the content searching application 512 and the content organizing application 514.

The content list sharing application 510 comprises logic for sharing a user's content list with other users. For example, the content list sharing application 510 comprises logic for sharing a user's content list with other users selected by the user. In addition, according to some embodiments of the present invention, the content list sharing application 510 comprises logic for sharing a user's content list with others based on the type of content other users are interested in. For example, a user's content list may be shared with a second user in response to the second user searching, via the network service, for content that is related to content on the user content list. In addition, according to some embodiments of the present invention, the content list sharing application 510 comprises logic for sharing a user's content list with a second user based on content identified in a content list that the second user has transmitted to the network service.

The content searching application 512 comprises logic for searching for content a user indicates he/she would like to obtain in the future. Upon locating such content, the content searching application can update/edit user content lists, according to some embodiments of the present invention.

The content organizing application 514 comprises logic for organizing/categorizing a user's content list. For example, a user's content list can be organized alphabetically, chronologically, by genre, by type of content, and/or by one or more combinations thereof, etc.

FIGS. 1-6 illustrate the architecture, functionality, and operations of some embodiments of methods, systems, and computer program products for organizing and sharing content. In this regard, each block represents a module, segment, or portion of code, which comprises one or more executable instructions for implementing the specified logical function(s). It should also be noted that in other implementations, the function(s) noted in the blocks may occur out of the order noted in FIGS. 1-4. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of organizing and sharing content via a communications network, comprising:
creating a user content list, comprising:
identifying content from multiple devices, domains and/or systems; and
providing an address for the identified content, wherein the address is an address from which the content can be retrieved via the network; and
sharing the user content list with selected other users via the network.

2. The method of claim 1, wherein identifying user content comprises tagging content via a device.

3. The method of claim 1, wherein identifying user content comprises rating and/or ranking the content.

4. The method of claim 1, further comprising accruing usage data for the content list.

5. The method of claim 1, wherein sharing the user content list comprises creating guides and listings of identified content.

6. The method of claim 1, wherein identifying user content comprises identifying content a user wishes to obtain.

7. The method of claim 1, wherein sharing the user content list comprises transmitting the user content list to a network service, wherein the network service is configured to share the user content list with selected other users via the network.

8. The method of claim 7, wherein the network service is configured to share the user content list with a second user in response to the second user searching, via the network, for content that is related to content on the user content list.

9. The method of claim 7, wherein the network service is configured to categorize the identified content.

10. The method of claim 7, wherein the network service is configured to share the user content list with a second user based on content identified in a second user content list transmitted to the network service by the second user.

11. The method of claim 1, wherein content comprises audio content, video content, text content, gaming content, interactive content, and/or application content.

12. The method of claim 1, wherein content comprises content generated by the user.

13. A system for organizing and sharing content with other users via a communications network, comprising:
a network service in communication with the network; and
a user device in communication with the network, wherein the user device comprises means for creating a user content list and means for transmitting the user content list to the network service;
wherein the means for creating a user content list comprises:
means for identifying content from multiple devices, domains and/or systems; and
means for providing an address for the identified content, wherein the address is an address from which the content can be retrieved via the network; and
wherein the network service is configured to share the user content list with selected other users via the network.

14. The system of claim 13, wherein the means for identifying user content comprises means for tagging content via the user device.

15. The system of claim 13, wherein the means for identifying user content comprises:
means for rating and/or ranking the content; and
means for creating guides and listings of identified content.

16. The system of claim 13, wherein the device is selected from the group consisting of personal computers, wireless communications devices, and packet-based network video devices.

17. The system of claim 13, wherein the user device further comprises means for identifying user content a user wishes to obtain, and wherein the network service is configured to search for content a user wishes to obtain.

18. The system of claim 13, wherein the network service is configured to share the user content list with a second user in response to the second user searching, via the network, for content that is related to content on the user content list.

19. The system of claim 13, wherein the network service is configured to share the user content list with a second user based on content identified on a second user content list transmitted to the network service by the second user.

20. A computer program product for organizing and sharing content via a communications network, comprising:
a computer readable storage medium having computer readable program code embodied therein, the computer readable program code being configured to carry out the method of claim 1.
